(19) United States
(12) Patent Application Publication
(10) Pub. No.: US 2015/0268840 A1
(43) Pub. Date: Sep. 24, 2015

(54) DETERMINATION OF A PROGRAM INTERACTION PROFILE BASED AT LEAST IN PART ON A DISPLAY REGION

(71) Applicant: Nokia Corporation, Espoo (FI)

(72) Inventors: Jussi Artturi LEPPANEN, Tampere (FI); Antti Johannes ERONEN, Tampere (FI); Arto Juhani LEHTINIEMI, Lempaala (FI)

(21) Appl. No.: 14/221,232

(22) Filed: Mar. 20, 2014

(51) Int. Cl. G06F 3/0484

(52) U.S. Cl. CPC G06F 3/04847; G06F 3/04842

(57) ABSTRACT

A method comprising determining a first display region in which to display a first program interaction screen associated with a program, determining a first program interaction profile for the program based, at least in part, on the first display region, generating the first program interaction screen based, at least in part, on the first program interaction profile, causing display of the first program interaction screen at a position that corresponds with the first display region, receiving information indicative of a program interaction screen transfer input, determining a second display region in which to display a second program interaction screen associated with the program based, at least in part, on the interaction screen transfer input, determining a second program interaction profile for the program based, at least in part, on the second display region, generating the second program interaction screen based, at least in part, on the second program interaction profile, and causing display of the second program interaction screen at a position that corresponds with the second display region is disclosed.

### TECHNICAL FIELD

The present application relates generally to determination of a program interaction profile based at least in part on a display region.

### BACKGROUND

As users have become more accustomed to interacting with electronic apparatuses, users have become more reliant on electronic apparatuses to perform operations. For example, the user may play media with the electronic apparatus, view information on the electronic apparatus, and/or the like. In some circumstances, the manner in which the user perceives and/or interacts with the apparatus may be impacted by the location in which the user interacts with his electronic apparatus. In this manner, it may be desirable to allow for determination of program interaction in a simple and intuitive manner.

### SUMMARY

Various aspects of examples of the invention are set out in the claims. One or more embodiments may provide an apparatus, a computer readable medium, a non-transitory computer readable medium, a computer program product, and/or a method for determining a first display region in which to display a first program interaction screen associated with a program, determining a first program interaction profile for the program based, at least in part, on the first display region, generating the first program interaction screen based, at least in part, on the first program interaction profile, causing display of the first program interaction screen at a position that corresponds with the first display region, receiving information indicative of a program interaction screen transfer input, determining a second display region in which to display a second program interaction screen associated with the program based, at least in part, on the interaction screen transfer input, determining a second program interaction profile for the program based, at least in part, on the second display region, generating the second program interaction screen based, at least in part, on the second program interaction profile, and causing display of the second program interaction screen at a position that corresponds with the second display region.

One or more embodiments may provide an apparatus, a computer readable medium, a computer program product, and/or a non-transitory computer readable medium having means for determining a first display region in which to display a first program interaction screen associated with a program, means for determining a first program interaction profile for the program based, at least in part, on the first display region, means for generating the first program interaction screen based, at least in part, on the first program interaction profile, means for causing display of the first program interaction screen at a position that corresponds with the first display region, means for receiving information indicative of a program interaction screen transfer input, means for determining a second display region in which to display a second program interaction screen associated with the program based, at least in part, on the interaction screen transfer input, means for determining a second program interaction profile for the program based, at least in part, on the second display region, means for generating the second program interaction screen based, at least in part, on the second program interaction profile, and means for causing display of the second program interaction screen at a position that corresponds with the second display region is disclosed.

In at least one example embodiment, a program interaction screen is visual information that comprises control interaction elements and at least one visual representation of content provided by the program.

In at least one example embodiment, the first program interaction profile is different from the second program interaction profile.

In at least one example embodiment, the first display region is a portion of a display that is less than an entirety of the display.

In at least one example embodiment, the second display region is a different portion of the display that is less than the entirety of the display.

In at least one example embodiment, the first display region and the second display region are non-overlapping.

In at least one example embodiment, the first display region is at least a portion of a display, and the second display region is at least a portion of a different display.

One or more example embodiments further perform termination of display of the first program interaction screen at the position that corresponds with the first display region, based at least in part on the program interaction screen transfer input.

In at least one example embodiment, the first program interaction profile is a data structure that governs interactive capabilities of the first program interaction screen.

In at least one example embodiment, the first program interaction profile comprises a first program control interaction profile, and generation of the first program interaction screen is based, at least in part, on the first program control interaction profile.

In at least one example embodiment, the first program control interaction profile is a data structure that governs invocation of operations of the program.

In at least one example embodiment, the operations of the program are functions that the program performs in response to one or more user inputs.

In at least one example embodiment, generation of the first program interaction screen comprises determination that the first program control interaction profile designates configuration of an operation, and the generation of the first program interaction screen is performed such that the first program interaction screen comprises a control interaction element that is configured to invoke the operation.

In at least one example embodiment, the program is a media player program and the operation is at least one of a volume adjustment operation, a media designation operation, a rewind operation, a fast-forward operation, a pause operation, or a play operation.

In at least one example embodiment, the program is a climate control program, and the operation is at least one of a temperature adjustment operation, a fan speed adjustment operation, or a climate mode adjustment.

In at least one example embodiment, the program is a map program, and the operation is at least one of a destination selection operation, a navigation invocation operation, a navigation termination operation, a point of interest search operation, or a point of interest selection operation.

In at least one example embodiment, the second program interaction profile comprises a second program control interaction profile, and generation of the second program interaction screen is based, at least in part, on the second program control interaction profile.

In at least one example embodiment, generation of the second program interaction screen comprises determination that the second program control interaction profile designates preclusion of the operation, and the generation of the second program interaction screen is performed such that the second program interaction screen excludes the control interaction element that is configured to invoke the operation.

In at least one example embodiment, generation of the first program interaction screen comprises determination that the first program control interaction profile designates preclusion of an operation, and the generation of the first program interaction screen is performed such that the first program interaction screen excludes a control interaction element that is configured to invoke the operation.

In at least one example embodiment, the second program interaction profile comprises a second program control interaction profile, and generation of the second program interaction screen is based, at least in part, on the second program control interaction profile.

In at least one example embodiment, generation of the second program interaction screen comprises determination that the second program control interaction profile designates configuration of the operation, and the generation of the second program interaction screen is performed such that the second program interaction screen comprises the control interaction element that is configured to invoke the operation.

In at least one example embodiment, the first program interaction profile comprises a first program content interaction profile, and generation of the first program interaction screen is based, at least in part, on the first program content interaction profile.

In at least one example embodiment, the first program content interaction profile is a data structure that governs presentation of content provided by the program.

In at least one example embodiment, the content provided by the program is information that the program causes to be rendered.

In at least one example embodiment, the information comprises at least one of audio information, text information, speech information, or visual information.

In at least one example embodiment, generation of the first program interaction screen comprises determination that the first program content interaction profile designates a first language, and the generation of the first program interaction screen is performed such that content comprised by the first program interaction screen conforms with the first language.

In at least one example embodiment, generation of the second program interaction screen comprises determination that the second program content interaction profile designates a second language, and the generation of the second program interaction screen is performed such that content comprised by the second program interaction screen conforms with the second language.

In at least one example embodiment, the first language is different from the second language.

In at least one example embodiment, generation of the first program interaction screen comprises determination that the first program content interaction profile allows presentation of a content type, and the generation of the first program interaction screen is performed such that the first program interaction screen comprises a representation of content that corresponds with the content type.

In at least one example embodiment, generation of the second program interaction screen comprises determination that the second program content interaction profile precludes presentation of the content type, and the generation of the second program interaction screen is performed such that the second program interaction screen fails to comprise a representation of content that corresponds with the content type.

In at least one example embodiment, the content type is indicative of an appropriateness rating.

In at least one example embodiment, the appropriateness rating identifies a rating threshold in accordance with at least one of a motion picture rating system, a video game rating system, a song rating system, a profanity rating system, or a television rating system.

One or more example embodiments further perform receipt of information indicative of a program interaction profile designation input, wherein the first program interaction profile is based, at least in part on the program interaction profile designation input.

In at least one example embodiment, the program is a video player program, the first display region is a passenger display region, the second display region is a driver display region, and generation of the second program interaction screen comprises causation of pausing of video information being rendered by the video player program such that the second program interaction screen comprises an image indicative of a paused frame of the video information.

In at least one example embodiment, the second program interaction profile comprises a second program control interaction profile that precludes a play operation.

One or more example embodiments further perform determination of a user identity of a user that is at a location that correlates with the second display region, wherein the determination of the second program interaction profile for the program is based, at least in part, on the user identity.

One or more example embodiments further perform receipt of information indicative of a user weight, wherein the determination of the user identity is based, at least in part, on the user weight.

One or more example embodiments further perform receipt of information indicative of an apparatus identity, wherein the determination of the user identity is based, at least in part, on the apparatus identity.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIGS. 2A-2C are diagrams illustrating display regions according to at least one example embodiment;

FIGS. 3A-3C are diagrams illustrating program interaction profiles according to at least one example embodiment;

FIGS. 4A-4D are diagrams illustrating program interaction screens according to at least one example embodiment;

FIGS. 5A-5E are diagrams illustrating program interaction screen transfer according to at least one example embodiment;

FIG. 6 is a flow diagram illustrating activities associated with determination of a program interaction profile based at least in part on a display region according to at least one example embodiment;

FIG. 7 is a flow diagram illustrating activities associated with determination of a program interaction profile based at least in part on a display region according to at least one example embodiment;

FIG. 8 is a flow diagram illustrating activities associated with determination of a program interaction profile based at least in part on a display region according to at least one example embodiment; and

FIG. 9 is a flow diagram illustrating activities associated with determination of a program interaction profile based at least in part on a display region according to at least one example embodiment.

### DETAILED DESCRIPTION OF THE DRAWINGS

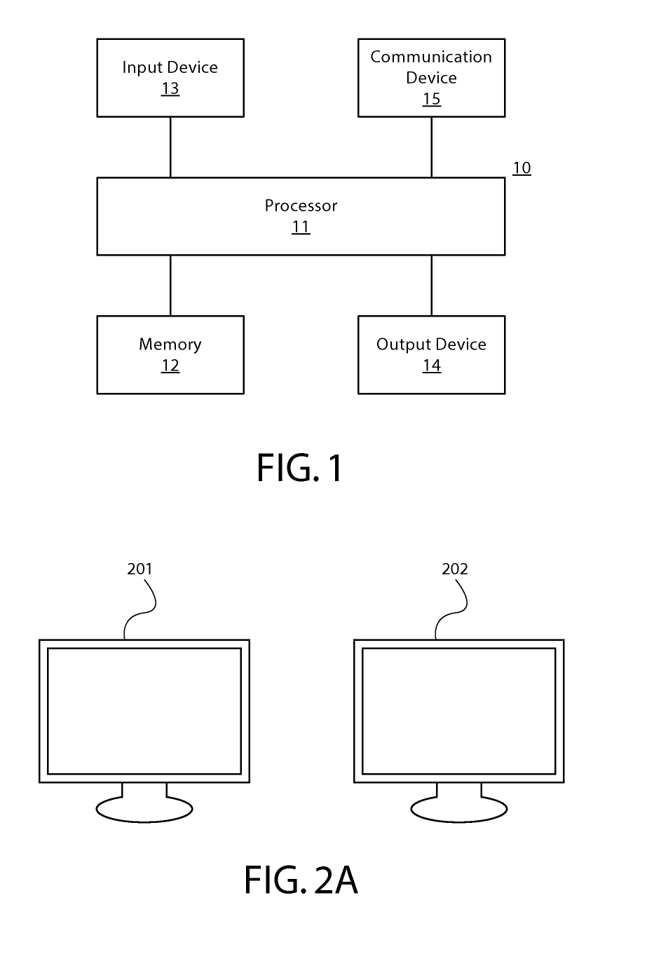

An embodiment of the invention and its potential advantages are understood by referring to FIGS. 1 through 9 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one example embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus, and/or the like. For example, the apparatus may send the information to a separate display, to a computer, to a laptop, to a mobile apparatus, and/or the like. For example, the apparatus may be a server that causes display of the information by way of sending the information to a client apparatus that displays the information. In this manner, causation of display of the information may comprise sending one or more messages to the separate apparatus that comprise the information, streaming the information to the separate apparatus, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition, or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display, or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

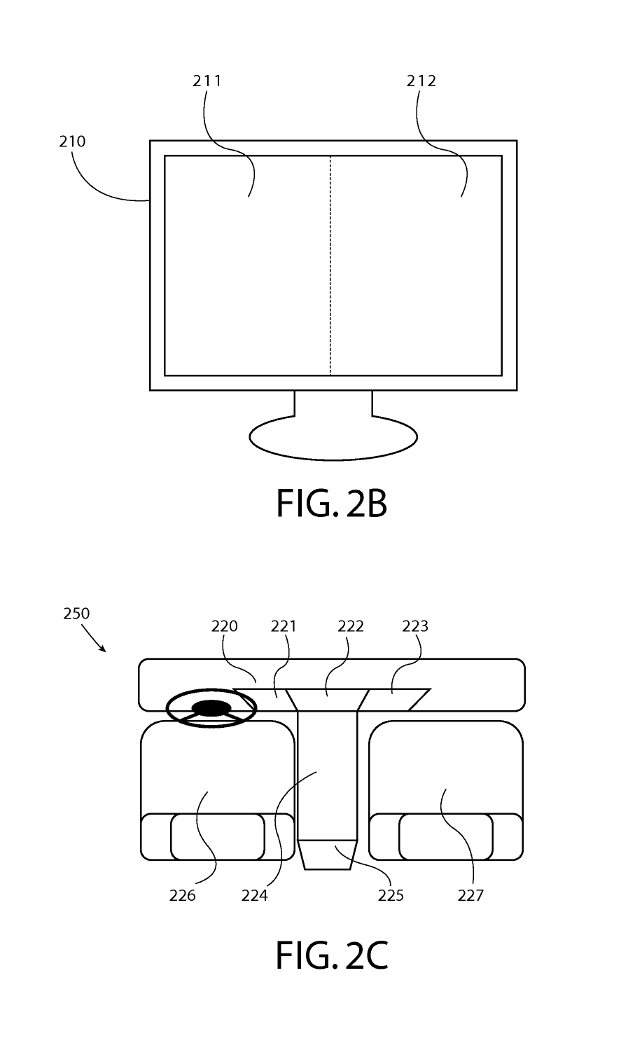

FIGS. 2A-2C are diagrams illustrating display regions according to at least one example embodiment. The examples of FIGS. 2A-2C are merely examples and do not limit the scope of the claims. For example, the number of display regions may vary, the orientation of display regions may vary, the position of display regions may vary, and/or the like.

In many circumstances, a user may desire to interact with an electronic device. In such circumstances, it may often be desirable for the user to interact with an electronic apparatus by way of a display region. For example, the user may interact with a program interaction screen associated with a program. It many cases, it may be desirable for device display to comprise multiple display regions. In this manner, the electronic apparatus may cause display of multiple program interaction screens in multiple display regions, allow interaction with multiple simultaneous users by way of multiple display regions, allow the repositioning of program interaction screens across multiple display regions, and/or the like.

The example of FIG. 2A illustrates display region 201 and display region 202. It can be seen that display region 201 is the entirety of a display and that display region 202 is the entirety of a different display. The entirety of the display refers to all areas on a display in which the display may display information. For example, the display may comprise an array of pixels. In such an example, the entirety of the display refers to all pixels within the array. Even though the example of FIG. 2A illustrates display region 201 being comprised by a separate apparatus from display region 202, in some circumstances, the separate displays may be comprised by a single apparatus, may be comprised by the apparatus with which the user is interacting, and/or the like. For example, the user may interact with an apparatus that is in communication with the displays that comprise display regions 201 and 202, may interact with an apparatus that comprises one or more of display regions 201 and 202, and/or the like.

The example of FIG. 2B illustrates display 210. Display 210 comprises display region 211 and display region 212. It can be seen that display region 211 is a portion of display 210 and that display region 212 is a different portion of display 210. In this manner, display region 211 is less than the entirety of display 210, and display region 212 is less than the entirety of display 210. For example, display 210 may comprise an array of pixels. In such an example, display region 211 refers to only a subset of the pixels within the array. In some circumstances, display 210 may be comprised by an apparatus that is separate from the apparatus with which the user is interacting, may be comprised by the apparatus with which the user is interacting, and/or the like. For example, the user may interact with an apparatus that is in communication with display 210, may interact with an apparatus that comprises display 210, and/or the like.

The example of FIG. 2C illustrates a vehicle 250. Vehicle 250 may be any vehicle such as an automobile, a watercraft, an aircraft, a train, a moped, and/or the like. Vehicle 250 further comprises a driver's seat 226, a passenger's seat 227, and console 220. Console 220 further comprises a display with display regions 221-225. It can be seen that display regions 221-225 are each a portion of console 220 less than the entirety of the display comprising console 220. While console 220 comprises a single display with multiple display regions, in some circumstances console 220 may comprise multiple displays. Display regions 221-225 are associated with different seats in vehicle 250 on this basis of their position. Display region 221 is associated with the driver's seat 226. Display 223 is associated with the front passenger seat 227. Display 225 is associated with rear passenger seats that are not illustrated in FIG. 2C. Display region 222 may be associated with either driver's seat 226, front passenger's seat 227, or both. Display region 224 may be associated with driver's seat 226, front passenger's seat 227, rear passenger seats that are not illustrated, or with any combination of driver's seat 226, front passenger's seat 227, and rear passenger seats that are not illustrated.

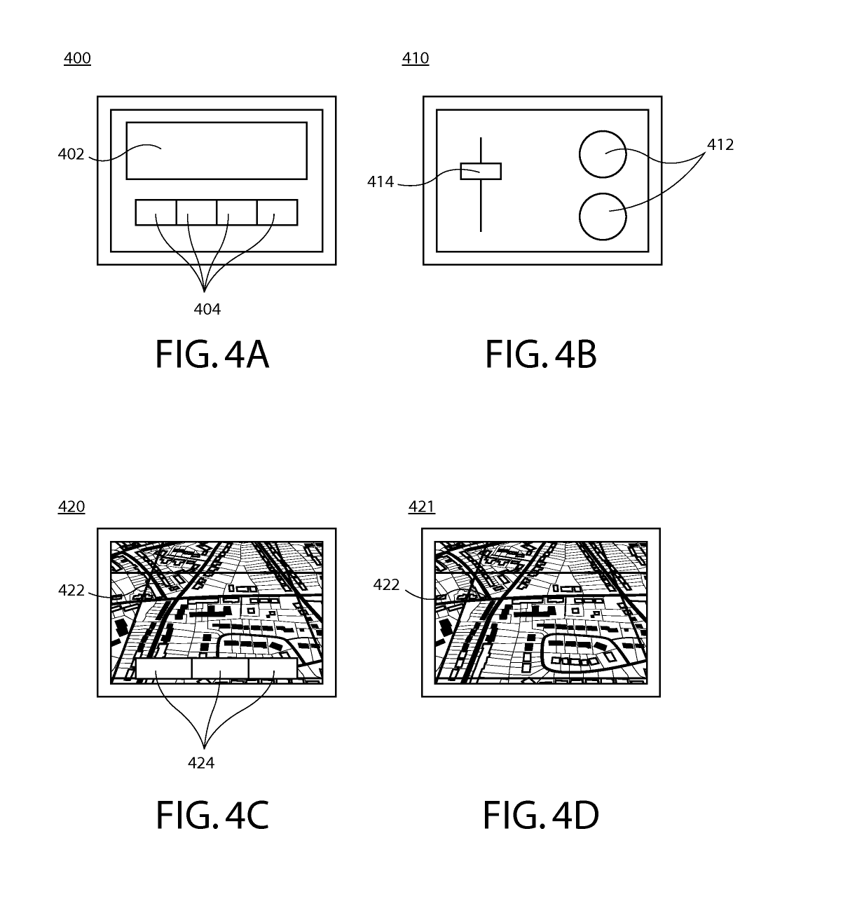

In at least one example embodiment, an apparatus determines a display region in which to display a program interaction screen associated with a program. A display region may be the entirety of a display on which information is displayed, similar as described regarding FIG. 2A, a portion of a display on which information is displayed separate from other information, similar as described regarding FIG. 2B, and/or the like. A program interaction screen may be similar as described regarding FIGS. 4A-4D.

In some circumstances, it may be desirable for users to interact with an apparatus by way of a plurality of display regions. In at least one example embodiment, one or more users interact with the apparatus by way of a first display region and a second display region. In at least one example embodiment, the first display region is at least a portion of a display, and the second display region is at least a portion of a different display. For example, an apparatus may determine to display a program interaction screen on display region 201 of FIG. 2A, display region 202 of FIG. 2A, and/or the like. In at least one example embodiment, the first display region is a portion of a display that is less than an entirety of the display and the second display region is a portion of the same display that is less than the entirety of the same display. For example, the first display region may be display region 211 of FIG. 2B and the second display region may be display region 212 of FIG. 2B. In at least one example embodiment, the first display region and the second display region are non-overlapping. Non-overlapping refers to a condition in which two display regions fail to share any common display area. For example, a display may comprise an array of pixels. In such an example, non-overlapping display regions may refer to the first display region failing to share any pixels with the second display region. It can be seen that display region 211 of FIG. 2B and display region 212 of FIG. 2B are non-overlapping, for at least the reason that they fail to share any common display area.

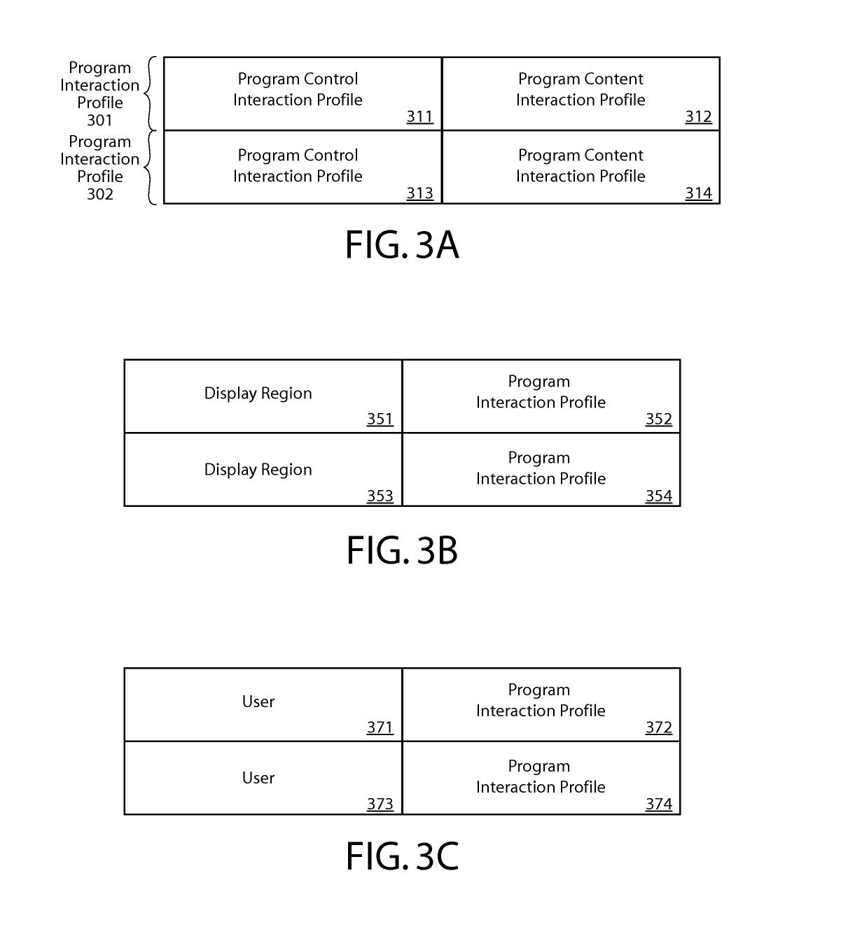

FIGS. 3A-3C are diagrams illustrating program interaction profiles according to at least one example embodiment. The examples of FIGS. 3A-3C are merely examples and do not limit the scope of the claims. For example, the number of program interaction profiles may vary, the information within the program interaction profiles may vary, the format of the program interaction profiles may vary, and/or the like.

In many circumstances, it may be desirable for an apparatus to interact with different users in different manners. For example, in an automobile, it may be desirable that the driver interact differently with the apparatus than a passenger. For instance, in circumstances where the apparatus is running a map program, the apparatus may allow interaction with more control when the apparatus is being used by the front passenger. For example, the apparatus may allow a passenger to change the route, browse the map, or look for points of interest, while limiting the driver to observing the route. In another example, it may be desirable that a parent interact differently with the apparatus than a child. For instance, the apparatus may allow full control of the apparatus to the parent, such as changing user preferences, viewing data on the apparatus, and/or the like, and only allowing the child basic functionality, such as displaying data allowed approved by the parent, altering a limited set of preferences and/or the like.

Oftentimes it may be desirable to generate a program interaction screen, based at least in part, on a program interaction profile. In at least one example embodiment a program interaction profile is a data structure that governs interactive capabilities of a program interaction screen. For example, the data structure may indicate a manner in which information is displayed, a manner in which a user may control a program, and/or the like. For example, the data structure may comprise information that indicates a particular language, a particular user interface preference, a particular set of allowed operations, and/or the like. In this manner, the program interaction screen may be tailored based, at least in part, on a program interaction profile. For example, the apparatus may disable particular controls intended for a driver when the program interaction screen is displayed on a passenger display region. In another example, the apparatus may display media a particular user prefers to play, and avoid display of media that the particular user prefers to avoid playing, with a media player program when the particular user is interacting with the apparatus.

In many circumstances, it may be desirable that a program interaction profile comprise one or more types of interaction profiles. For example, a program interaction profile may comprise an interaction profile that governs control and/or an interaction profile that governs content. Such a program interaction profile may allow easier management of profiles on the apparatus. For example, it may be easier for the apparatus to manage display language in a particular interaction profile that governs content, and manage program functionality in a particular interaction profile that governs control.

The example of FIG. 3A illustrates first program interaction profile 301 and second program interaction profile 302. First program interaction profile 301 further comprises program control interaction profile 311 and program content interaction profile 312. Second profile interaction profile 302 further comprises program control interaction profile 313 and program content interaction profile 314.

It may be desirable that a program interaction profile comprise a program control interaction profile. In at least one example embodiment, a program interaction profile comprises a program control interaction profile. In at least one example embodiment, a program control interaction profile is a data structure that governs invocation of operations of the program. In at least one example embodiment, the operations of the program are functions that the program performs in response to one or more user inputs. In at least one example embodiment, the program control interaction profile designates configuration of an operation. In at least one example embodiment, designating configuration of the operation refers to causing the program to provide an interface element that allows for invocation of the operation. In this manner, the apparatus may allow a user to invoke an operation of the program based, at least in part, on the program control interaction profile. For example, the program may be a media player program. In such an example, the program control interaction profile may designate configuration of a volume operation such that a user of the media player program may invoke an operation for adjusting the volume. In at least one example embodiment, the designation of configuration of the operation refers to limiting performance of the operation to be within one or more predetermined constraints. For example, the operation may be an adjustment of a parameter. In such an example, the constraints may refer to a maximum value, a minimum value, and/or the like. For example, a volume adjustment operation may be constrained by a minimum volume, a maximum volume, and/or the like.

In at least one example embodiment, the program control interaction profile designates preclusion of an operation. In at least one example embodiment, designating preclusion of the operation refers to precluding the program from providing an interface element that allows for invocation of the operation. In this manner, the apparatus may preclude a user from invoking the operation. For example, the program may be a media player program. In such an example, the control interaction profile may designate preclusion of control of a volume operation such that a user is prevented from invoking an operation for adjusting the volume.

In many circumstances, it may be desirable that a program interaction profile comprise a program content interaction profile. In at least one example embodiment, a program interaction profile comprises a program content interaction profile. In at least one example embodiment, a program content interaction profile is a data structure that governs presentation of content provided by the program. In this manner, the apparatus may govern the manner in which content is displayed, based, at least in part, on the content interaction profile. In at least one example embodiment, the program content interaction profile designates a language. In at least one example embodiment, the apparatus causes display of content by way of generation of a program interaction screen, similar as described regarding FIGS. 4A-4D. In this manner, the generation of the program interaction screen may be performed such that content comprised by the program interaction screen conforms with the language. In at least one example embodiment, conformance with a language refers to textual information conveying words that correspond with the language. For example, the program interaction profile may designate English as the language. In such an example, the apparatus may generate the program interaction screen to utilize English text.

In at least one example embodiment, the program content interaction profile allows presentation of a content type. In this manner, the apparatus may then display such content on a program interaction screen. For example, the program content interaction profile may allow presentation of explicit content, such as music with explicit lyrics, movies with adult themes and/or the like. In at least one example embodiment, the program content interaction profile precludes presentation of the content type. In this manner, the apparatus may then preclude display of such content on a program interaction screen. For example, the program content interaction profile may preclude presentation of explicit content, such as music with explicit lyrics, movies with adult themes and/or the like. In at least one example embodiment, the content type is indicative of an appropriateness rating. In at least on embodiment, the appropriateness rating identifies a rating threshold in accordance with at least one of a motion picture rating system, a video game rating system, a song rating system, a profanity rating system, or a television rating system.

In many circumstances, it may be desirable for a display region to be associated with a program interaction profile. The example of FIG. 3B illustrates examples of program interaction profiles that are associated with different display regions. First display region 351 is associated with first program interaction profile 352, and second display region 353 is associated with second program interaction profile 354.

In at least one example embodiment, the apparatus determines a program interaction program profile for the program based, at least in part, on a display region. In this manner, the apparatus may generate a program interaction screen on the display region based, at least in part, on the program interaction profile. For example, the apparatus may determine that first program interaction profile 352 of FIG. 3B is associated with first display region 351. In such an example, the apparatus may display a program interaction screen on first display region 351 based, at least in part, on first program interaction profile 352.

In many circumstances, it may be desirable for a user to be associated with a program interaction profile. The example of FIG. 3C illustrates examples of program interaction profiles that are associated with different users. First user 371 is associated with first program interaction profile 372, and second user 373 which is associated with second program interaction profile 374.

In at least one example embodiment, an apparatus determines a user identity of a user that is at a location that correlates with a display region. In this manner, the apparatus may determine a program interaction profile for the program based, at least in part, on the user identity. For example, in a vehicle, the apparatus may determine the identity of a user sitting in a back seat that correlates with a particular display region. The apparatus may then determine an appropriate program interaction profile for the display region. For example, the apparatus may determine that user 371 of FIG. 3C is using a particular display region. In such an example, the apparatus may generate a program interaction screen based, at least in part, on program interaction profile 372. In at least one example embodiment, the apparatus receives information indicative of a user weight. For example, the apparatus may receive information from a weight sensor embedded in a seat that is in communication with the apparatus. In such an example, the determination of the user identity may be based, at least in part, on the user weight. For example, a user weight may correlate with a particular program interaction profile associated with a weight of a user. In at least one example embodiment, the apparatus receives information indicative of an apparatus identity. An apparatus identity refers to the identity of an apparatus possessed by a user. For example, the user may possess a cellular telephone, a tablet computer, an RFID device, and/or the like. In such an example, the apparatus may identify a user by way of identifying the apparatus possessed by the user. For example, the apparatus may identify the apparatus by way of a charger connection, communicating with the apparatus, and/or the like. In this manner, the determination of the user identity may be based, at least in part, on the apparatus identity. For example, an apparatus identity may correlate with a particular program interaction profile associated with a user.

In many instances, it may be desirable for a user to designate a program interaction profile. For example, the apparatus may be used in an automobile. In such an example, the driver may wish to designate a program interaction profile for a particular passenger. For instance, a driver sitting in driver's seat 226 of FIG. 2C could designate a program interaction profile for a passenger sitting in front passenger seat 227. It often may be desirable to limit the ability to designate a program interaction profile to a particular display region. For example, the apparatus may be used in an automobile. In such an example, the ability to designate a program interaction profile may be limited to a display region associated with the driver. For instance, the ability to designate a program interaction profile may be limited to display region 221 of FIG. 2C. In at least one example embodiment, the apparatus receives information indicative of a program interaction profile designation input. In this manner, a program interaction profile may be based, at least in part, on the program interaction profile designation input. For example, a program interaction profile may be based, at least in part, on a program interaction profile designation input received from a driver sitting in driver's seat 226 of FIG. 2C.

FIGS. 4A-4D are diagrams illustrating program interaction screens according to at least one example embodiment. The examples of FIGS. 4A-4D are merely examples and do not limit the scope of the claims. For example, the programs may vary, the interaction elements may vary, the graphics may vary, and/or the like.

As previously described, it may often be desirable for an apparatus to display a program interaction screen associated with a program on a display region. In at least one example embodiment, a program interaction screen is visual information that comprises control interaction elements and at least one visual representation of content provided by the program. In at least one example embodiment, the content provided by the program is information that the program causes to be rendered. In at least one example embodiment, the information the program causes to be rendered comprises at least one of audio information, text information, speech information, or visual information. For example, the content may be a video, a song, a still image, and/or the like.

Control interaction elements may comprise elements that enable a user to invoke one or more operations of the program. For example, a control interaction element may be one or more menus, menu items, icons, control widgets, tabs, and/or the like. In at least one example embodiment, a control interaction element is configured to invoke an operation. In at least one example embodiment, a control interaction element being configured to invoke an operation refers to the ability of a control interaction element to be manipulated by a user, such that the manipulation invokes an operation of the program. As previously described in regards to FIGS. 3A-3C, operations of the program may comprise functions that the program performs in response to one or more user inputs.

Often, it may be desirable to generate a program interaction screen based on a program interaction profile similar as described regarding FIGS. 3A-3C. For example, in an automobile, it may be desirable to generate a program interaction screen on a display region associated with a driver's seat, and a different program interaction screen upon a display region associated with a front passenger's seat.

In at least one example embodiment, the program is a media player program and the operation is at least one of a volume adjustment operation, a media designation operation, a rewind operation, a fast-forward operation, a pause operation, or a play operation. A media player program may be a program that enables an apparatus to render media such as audio, video, still images, and/or the like. For example, a media player program may render audio received from a radio station or audio file, or render video from a source such as a DVD or video file. The example of FIG. 4A illustrates program interaction screen 400. Program interaction screen 400 is representative of visual information for a media player program. Program interaction screen 400 comprises visual representation of content 402 and control interaction elements 404. Control interaction elements 404 may control program operations such as volume, media designation, and/or the like. Program interaction screen 400 may be generated based, at least in part, on a program interaction profile. For example, in a vehicle the apparatus may determine from a program interaction profile that a display region associated with the driver's seat of the vehicle is precluded from displaying video, and visual representation of content 402 may exclude video when displayed on a display region associated with a driver's seat. In another example, control interaction elements 404 may only include a volume adjustment operation for a display regions associated with front seats.

In at least one example embodiment, the program is a climate control program, and the operation is at least one of a temperature adjustment operation, a fan speed adjustment operation, or a climate mode adjustment. A climate control program may be a program that enables an apparatus to control the climate of an area associated with the apparatus. For example, a climate control program could control the heating, ventilation, and air conditioning (HVAC) system of a household associated with the apparatus, control the climate system of a vehicle associated with the apparatus, and/or the like. The example of FIG. 4B illustrates program interaction screen 410. Program interaction screen 410 is representative of visual information for a climate control program. Program interaction screen 410 comprises visual representation of content 412 and control interaction elements 414. Control interaction elements 414 may control program operations such as temperature, mode, and/or the like. Program interaction screen 410 may be generated based, at least in part, on a program interaction profile. For example, in a vehicle the apparatus may determine from a program interaction profile that only display regions associated with the driver's seat of the vehicle are allowed to display the climate control mode, and visual representation of content 412 may exclude climate control mode information when displayed on one or more display regions associated with passenger seats. In another example, control interaction elements 414 may only include a temperature adjustment operation for display regions associated with passenger seats, but include all available operations for display regions associated with a driver's seat.

In at least one example embodiment, the program is a map program, and the operation is at least one of a destination selection operation, a navigation invocation operation, a navigation termination operation, a point of interest search operation, or a point of interest selection operation. A map program may be a program that displays mapping information to a user of an apparatus, such as a location, a destination, points of interest, and/or the like. For example, a map program may display the current location of the apparatus, a vehicle associated with the apparatus, a different apparatus, such as a cellular telephone, and/or the like. The example of FIG. 4C illustrates program interaction screen 420. Program interaction screen 420 is representative of visual information for a map program. Program interaction screen 420 comprises visual representation of content 422 and control interaction elements 424. Control interaction elements 424 may control program operations such as destination selection, navigation, and/or the like. Program interaction screen 420 may be generated based, at least in part, on a program interaction profile. For example, in a vehicle the apparatus may determine from a program interaction profile that only display regions associated with passenger seats of the vehicle are allowed to display points of interest, and visual representation of content 422 may exclude points of interest information when displayed on a display region associated with a driver's seat. In another example, control interaction elements 424 may only include a navigation operation for display regions associated with the driver's seat, but exclude a navigation operation for display regions associated with passenger seats.

FIG. 4D illustrates second program interaction screen 421. Program interaction screen 421 is representative of visual information for a map program. Program interaction screen 421 comprises visual representation of content 422. Second program interaction screen 421 may be a program interaction screen for the same map program of FIG. 4C. For example, program interaction screen 420 may be displayed on a first display region, and second program interaction screen 421 may be displayed on a second display region.

In at least one example embodiment, apparatus generates a program interaction screen based, at least in part, on a program interaction profile. In at least one example embodiment, the generation of the program interaction screen comprises determination that a program control interaction profile designates configuration of an operation. In this manner, the generation of the program interaction screen may be performed such that the first program interaction screen comprises a control interaction element that is configured to invoke an operation, based at least in part, on a control interaction profile designating configuration of an operation. For example, in the embodiment of FIG. 4C, a control interaction profile may designate configuration of operations by control interaction elements 424. In at least one example embodiment, the generation of the program interaction screen comprises determination that a program control interaction profile designates preclusion of an operation. In this manner, the generation of the program interaction screen may be performed such that the program interaction screen excludes a control interaction element that is configured to invoke an operation. For example, in the embodiment of FIG. 4D, a control interaction profile may designate preclusion of operations by control interaction elements 424 associated with the map program of the example of FIG. 4C. It can be seen that the example of FIG. 4D that program interaction screen 421 excludes interaction elements 424.

In at least one example embodiment, the generation of a program interaction screen comprises determination that the program content interaction profile allows presentation of a content type. In this manner, the generation of the program interaction screen may be performed such that the program interaction screen comprises a representation of content that corresponds with the content type. For example, the program interaction screen may be generated such that it comprises explicit content allowed by the program content interaction profile. In at least one example embodiment, the generation of a program interaction screen may comprise determination that a program content interaction profile precludes presentation of a content type. In this manner, the generation of the program interaction screen may be performed such that the program interaction screen fails to comprise a representation of content that corresponds with the content type. For example, the program interaction screen may be generated such that it fails to comprise explicit content precluded by the program content interaction profile.

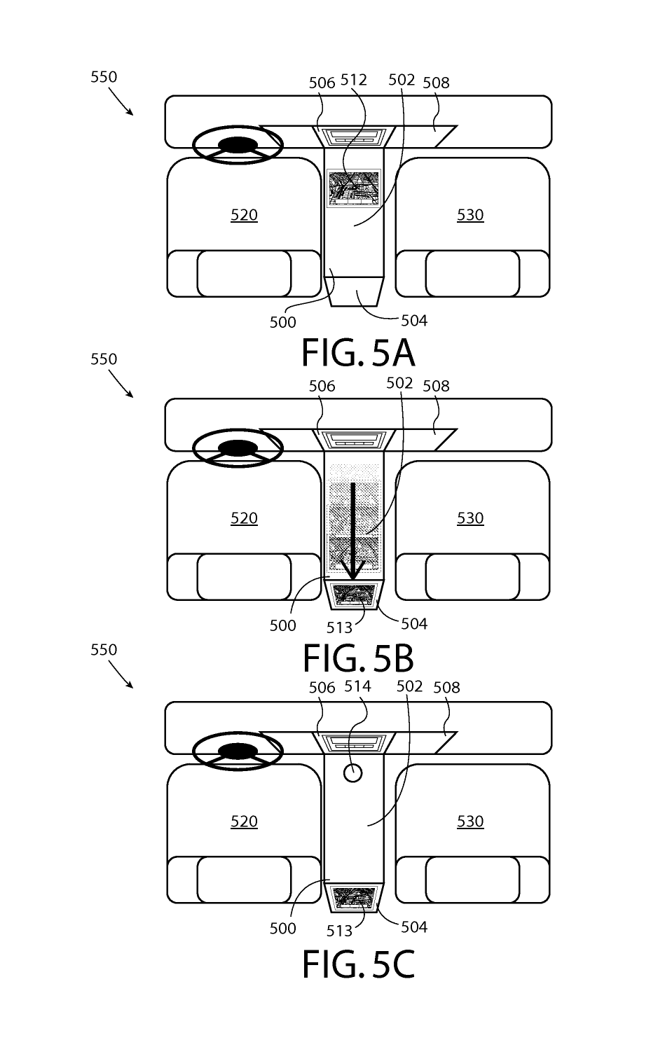

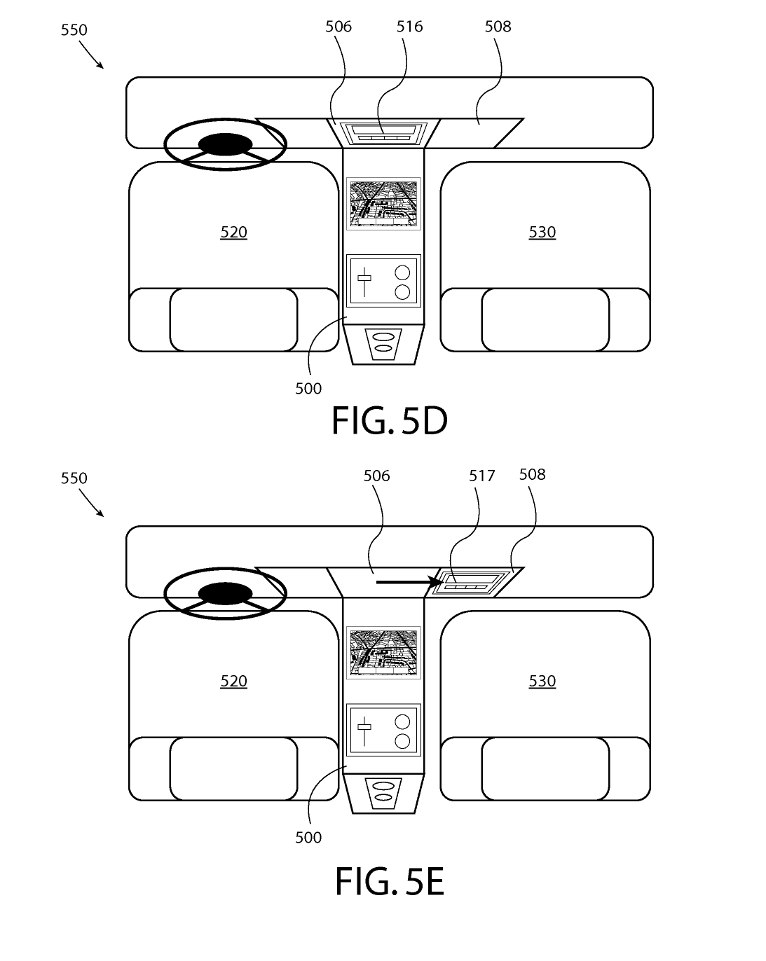

FIGS. 5A-5E are diagrams illustrating program interaction screen transfer according to at least one example embodiment. The examples of FIGS. 5A-5E are merely examples and do not limit the scope of the claims. For example, the program interaction screens may vary, display regions may vary, the program interaction profiles may vary, and/or the like.

As described regarding FIGS. 2A-2C, an apparatus may cause display of a program interaction screen in a display region. In at least one example embodiment, the apparatus causes display of the program interaction screen at a position that corresponds with a display region. For example, the display region may include the position at which the program interaction screen is displayed. In this manner, at least a portion of the program interaction screen may be comprised by the display region.

Often it may be desirable to transfer the program interaction screen to a different display region. For example, the apparatus may be used in an automobile. In such an example, the driver may wish to transfer interaction associated with a map program to a passenger. For instance, vehicle 250 of FIG. 2C may be displaying a map program interaction screen similar to as described in FIGS. 4C-4D on display region 220 and a driver may wish to transfer the program information screen to display region 223. In another example, a passenger may have limited control of a media player program, and may wish to transfer the media player program interaction screen to another passenger whose program interaction profile designates more control. For example, the driver of vehicle 250 may have limited the ability of a passenger to control the volume of a media player program. In such an example, the passenger may transfer the media player program interaction screen to a display region associated with the driver so that the driver may adjust the volume.

The example of FIGS. 5A-5E illustrates program interaction screen transfer between various display regions in a vehicle 550. Vehicle 550 comprises driver seat 520, front passenger seat 530, and console 500. Console 500 further comprises one or more displays that comprise display regions 502, 504, 506, and 508. It can be seen that display regions 502 and 504 correspond with different portions of console 500. In some circumstances, console 500 may comprise a single display with multiple display regions, multiple displays that comprise one or more display regions, and/or the like. It can be seen that display regions 506 and 508 correspond with different portions of a dashboard of vehicle 550. In some circumstances, the dashboard may comprise a single display with multiple display regions, multiple displays that comprise one or more display regions, and/or the like.

In the examples of FIGS. 5A-5E, display regions 502, 504, 506, and 508 are associated with different seats in vehicle 550 on this basis of their position in vehicle 550. Display region 502 and display region 506 are associated with the driver seat 520 and/or with passenger seat 530, by way of the central position between driver seat 520 and passenger seat 530. Display 508 is associated with the front passenger seat 530 by way of being closer to passenger seat 530 than to driver seat 520. Display 504 is associated with rear passenger seats that are not illustrated in FIGS. 5A-5C by way of being more accessible from a rear seat than from driver seat 520 or from passenger seat 530.

In many circumstances, it may be desirable for a person to be able to cause transfer of a program interaction screen by way of an input. In at least one example embodiment, an apparatus receives information indicative of a program interaction screen transfer input. In at least one example embodiment, a program interaction screen transfer input is an input that indicates a user's desire to relocate a program interaction screen from a display region to a different display region. For example, the program interaction screen transfer input may be a drag input that identifies the program interaction screen and indicates a different display region in which to display the program interaction screen. For example, the drag input may comprise an initial contact portion of the drag input that corresponds with the program interaction screen, and a movement portion of the drag input in a direction towards the different display region.

In at least one example embodiment, the apparatus determines a different display region to display the program interaction screen based, at least in part, on the program interaction screen transfer input. For example, the program interaction screen transfer input may comprise information indicative of the different display region, such as a movement portion of the drag input. In such an example, the apparatus may determine the different display region based, at least in part, on the information indicative of the different display region.

In at least one example embodiment, transfer of a program interaction screen comprises transition of the program interaction screen of a program from a display region to a different display region. In such circumstances, it may be desirable to determine a different program interaction screen of the program based, at least in part, on the different display region. For example, the display region may be associated with a program interaction profile, and the different display region may be associated with a different program interaction profile. In such an example, the apparatus may generate the different program interaction screen based, at least in part, on the different program interaction profile. In at least one example embodiment, the apparatus terminates display of the program interaction screen at a position that corresponds with the display region, based at least in part on a program interaction screen transfer input.

For example, an apparatus in vehicle 550 may receive a program interaction screen transfer input from either a driver or a front seat passenger who wishes to transfer program interaction screen 512 from FIG. 5A to a different display region. For example, the driver may wish to transfer program interaction screen 512 from display region 502 to display region 504. The example of FIG. 5A illustrates display regions 502 and 504 before a program interaction screen transfer input associated with program interaction screen 512, and FIG. 5B illustrates display regions 502 and 504 after a program interaction screen transfer input. It can be seen that the apparatus has generated program interaction screen 513, and caused display of program interaction screen 513 in display region 504. In the examples of FIGS. 5A-5B, the differences between program interaction screen 512 and program interaction screen 513 may be attributable to display region 502 being associated with a different program interaction profile than that of display region 504. It can be seen that FIG. 5B does not illustrate display of program interaction screen 512 as illustrated by FIG. 5A. It should be understood in this example that display of program interaction screen 512 in display region 502 has been terminated in the illustration of FIG. 5B.

In many circumstances it may be desirable to display an animation when transferring a program interaction screen to a different display region. In such circumstances, the animation may alert a user to the presence of the program interaction screen. For example, in the illustration of FIG. 5B, it can be seen that an animation was generated on display region 502 when a program interaction screen was transferred to display region 504. This animation may help to alert a passenger in a back seat to the presence of program interaction screen 513, may help a user understand that a program interaction screen transfer input was received by the apparatus, and/or the like.

In many circumstances, it may be desirable to change the program interaction screen of a program when the apparatus transfers the program interaction screen from a first display region to a second display region. For example, upon a transfer of a first program interaction screen of a program from the first display region, the apparatus may generate and display a second program interaction screen of the program at the second display region. For example, the second display region may have a different program interaction profile than the first display region.

In at least one example embodiment, generation of a first program interaction screen comprises determination that a first program control interaction profile designates preclusion of an operation. For example, the first program control interaction profile may be associated with display region 504. In such an example, the generation of the first program interaction screen may be performed such that the first program interaction screen excludes a control interaction element that is configured to invoke the operation. For example, the first program interaction screen may be similar to program interaction screen 421 of FIG. 4D. In such an example, the apparatus may receive a program interaction screen transfer input. Based, at least in part, on the program interaction screen transfer input, the apparatus may determine that a second program control interaction profile designates configuration of the operation. For example, the second program control interaction profile may be associated with display region 508. In such an example, the generation of the second program interaction screen may be performed such that the second program interaction screen comprises the control interaction element that is configured to invoke the operation. For example, the second program interaction screen may be similar to program interaction screen 420 of FIG. 4C.

In at least on example embodiment, generation of a first program interaction screen comprises determination that a first program control interaction profile designates configuration of an operation. For example, the first program control interaction profile may be associated with display region 508. In such an example, the generation of the first program interaction screen may be performed such that the first program interaction screen comprises a control interaction element that is configured to invoke the operation. For example, the first program interaction screen may be similar to program interaction screen 420 of FIG. 4C. In such an example, the apparatus may receive a program interaction screen transfer input. Based, at least in part, on the program interaction screen transfer input, the apparatus may determine that a second program control interaction profile designates preclusion of the operation. For example, the second program control interaction profile may be associated with display region 506. In such an example, the generation of the second program interaction screen may be performed such that the second program interaction screen excludes the control interaction element that is configured to invoke the operation. For example, the second program interaction screen may be similar to program interaction screen 421 of FIG. 4D.

In some circumstances, it may be desirable that a transferred program interaction screen be displayed in a different language. For example, a first user may speak English, and a second user may speak Spanish. In at least one example embodiment, generation of the first program interaction screen comprises determination that the first program content interaction profile designates a first language. For example, the first program control interaction profile may designate English. In such an example, the generation of the first program interaction screen may be performed such that the first program interaction screen comprises English text. In such an example, the apparatus may receive a program interaction screen transfer input. Based, at least in part, on the program interaction screen transfer input, the apparatus may determine that a second program control interaction profile designates a second language. For example, the second program control interaction profile may designate Spanish. In such an example, the generation of the second program interaction screen may be performed such that the second program interaction screen comprises Spanish text.

In some circumstances, it may be desirable that a transferred program interaction screen be displayed in a manner that particular content type is excluded. For example, a first user may be watching a video with explicit content, and the explicit content may be inappropriate for a second user. In at least one example embodiment, generation of the first program interaction screen comprises determination that the first program content interaction profile allows presentation of a content type. For example, the first program control interaction profile may allow presentation of explicit content. In such an example, the generation of the first program interaction screen may be performed such that the first program interaction screen comprises explicit content. In such an example, the apparatus may receive a program interaction screen transfer input. Based, at least in part, on the program interaction screen transfer input, the apparatus may determine that a second program control interaction profile precludes presentation of a content type. For example, the second program control interaction profile may preclude presentation of explicit content.

Often it may be desirable to retrieve a previously transferred program interaction screen from a different display region. For example, a user may desire to display the program interaction screen by causing the program interaction screen to return to the display region from which the user previously transferred the program interaction screen. For example, a vehicle driver may have transferred a media player program interaction screen from display region 502 to display region 504, but wishes to regain control of the media player program. Such retrieval can occur by the user utilizing a retrieval indicator screen.

In at least one example embodiment, the apparatus causes display of a retrieval indicator in a display region subsequent to termination of display of a program interaction screen. For example, a program interaction screen transfer input may cause termination of display of a program interaction screen in a first display region and display of another program interaction screen in a second display region based, at least in part, on a program interaction screen transfer input. In such an example, the apparatus may terminate display of the other program interaction screen on the second display region and cause display of the program interaction screen on the first display region based, at least in part, on an input associated with the retrieval indictor. The retrieval indicator may be any interaction element that indicates the program interaction screen, a retrieval operation, and/or the like. For example, FIG. 5C illustrates a retrieval indicator 514. In circumstances where the driver performs an input associated with retrieval indicator 514, the apparatus may terminate display of interaction screen 513 in display region 504 and cause display of interaction screen 512 in display region 502 similar as illustrated in FIG. 5A.

In at least one example embodiment, a program interaction profile comprises a program control interaction profile that precludes a play operation. For example, the interaction profile may be associated with a display region for a driver of a vehicle. For example, in some circumstances, the apparatus may cause display of a program interaction screen of a video program. In such circumstances it may be desirable for the apparatus to pause the video. For example, the video may be a safety hazard in circumstances where the video distracts the driver while the vehicle is in motion. For example, a passenger may be viewing a video player program interaction screen in display region 504. In such an example, the apparatus may terminate display of the video player program interaction screen in display region 504. The apparatus may generate a different video player program interaction screen to be displayed in display region 506. In such an example, the generation of the different video player program interaction screen may comprise causation of pausing of video information being rendered by the video player program such that the different video player program interaction screen comprises an image indicative of a paused frame of the video information.

The example FIG. 5D illustrates several program interaction screens in a line across display regions on console 500. It often may be desirable to move a program interaction screen away from driver seat 520 and towards passenger seat. In this manner, the apparatus may terminate display of program interaction screen 516. The example of FIG. 5E illustrates program interaction screen 517 subsequent to termination of display of program interaction screen 516. In the example of FIG. 5E, causation of display of 517 may have been caused by the termination of display of program interaction screen 516 from display region 506. In this manner, program interaction screen 516 may be interpreted as being replaced by program interaction screen 517.

In some circumstances, it may be desirable to transfer a series of program interaction screens sequentially across display regions in a manner such that they were on a conveyor belt moving from display region to adjacent display region. In some circumstances, it may be desirable to transfer a portion of a program interaction screen to a different display region. For example, a user may wish to transfer the control interaction elements of a program interaction screen without transferring the visual representation of content. In circumstances such as these, the user may then transfer the remaining portion of the program interaction screen to a different display such that the previously transferred portion of the program interaction screen is not transferred.

In some circumstances, the apparatus may determine to transfer a program interaction screen associated with a program from a display region that fails to have an adjacent display region in which to transfer the program interaction screen. For example, the apparatus may determine to transfer a program interaction screen from a display region located on a passenger door which is non-adjacent to any other display regions. In such an example, the apparatus may cause display of another program interaction screen associated with the program in a display region that fails to have an adjacent display region from which a different program interaction screen may be transferred. For example, the apparatus may cause display of another program interaction screen in a display region on an opposite passenger door.

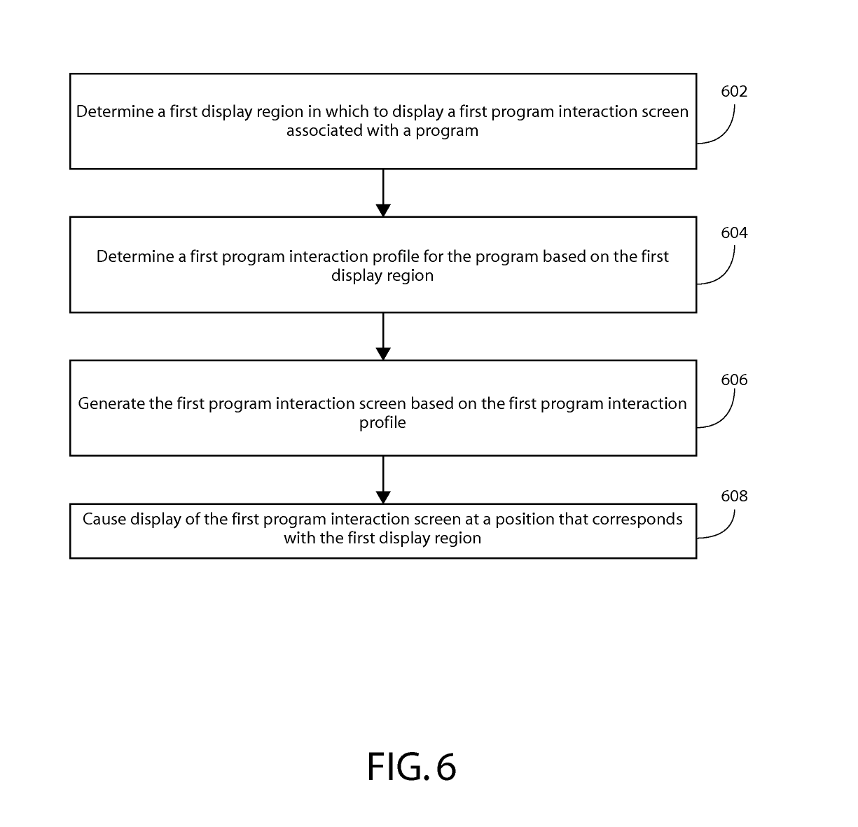

FIG. 6 is a flow diagram illustrating activities associated with determination of a program interaction profile based at least in part on a display region according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

At block 602, the apparatus determines a first display region in which to display a first program interaction screen associated with a program. The determination, the first display region, and the first program interaction screen may be similar as described regarding FIGS. 2A-2C and FIGS. 4A-4D.

At block 604, the apparatus determines a first program interaction profile for the program based, at least in part, on the first display region. The determination and the first program interaction profile may be similar as described in FIGS. 3A-3C.

At block 606, the apparatus generates the first program interaction screen based, at least in part, on the first program interaction profile. The generation may be similar as described in FIGS. 4A-4D.

At block 608, the apparatus causes display of the first program interaction screen at a position that corresponds with the first display region. The causation and the position may be similar as described in FIGS. 2A-2C and FIGS. 5A-5E.

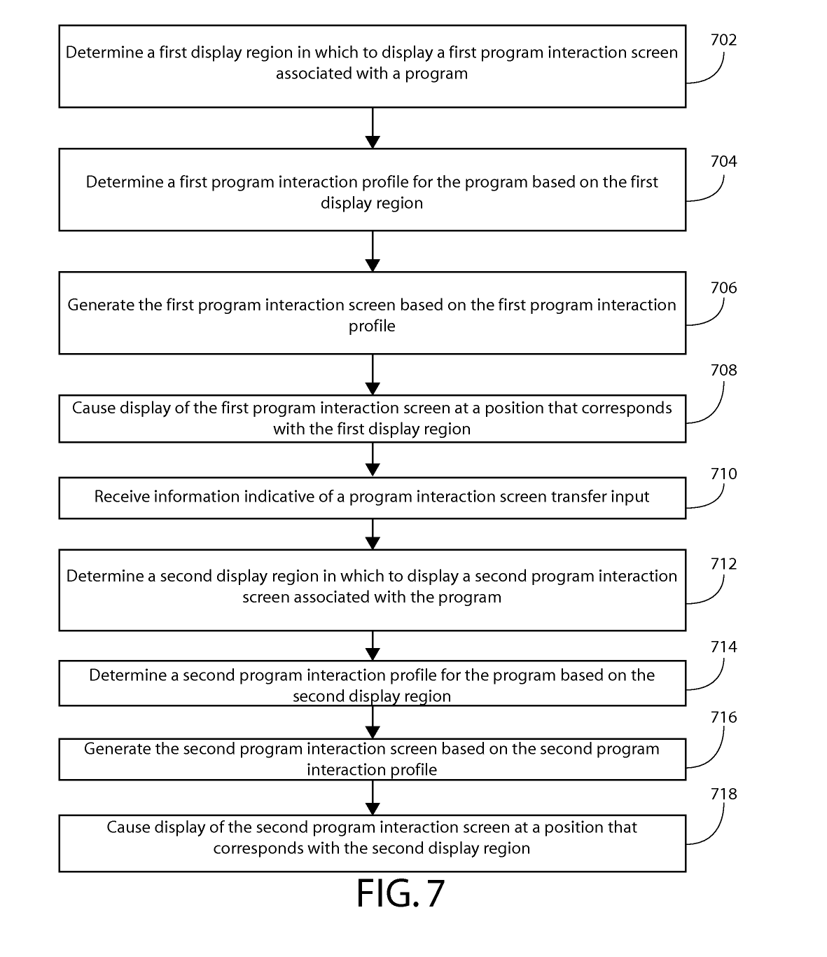

FIG. 7 is a flow diagram illustrating activities associated with determination of a program interaction profile based at least in part on a display region according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

As previously described, in some circumstances, it may be desirable to transfer a program interaction screen to a second display region.

At block 702, the apparatus determines a first display region in which to display a first program interaction screen associated with a program, similarly as described regarding block 602 of FIG. 6. At block 704, determines a first program interaction profile for the program based, at least in part, on the first display region, similarly as described regarding block 604 of FIG. 6. At block 706, the apparatus generates the first program interaction screen based, at least in part, on the first program interaction profile, similarly as described regarding block 606 of FIG. 6. At block 708, the apparatus causes display of the first program interaction screen at a position that corresponds with the first display region, similarly as described regarding block 608 of FIG. 6.

At block 710, the apparatus receives information indicative of a program interaction screen transfer input. The receipt and program interaction screen transfer input may be similar as described in FIGS. 5A-5E.

At block 712, the apparatus determines a second display region in which to display a second program interaction screen associated with the program based, at least in part, on the interaction screen transfer input. The determination, the second display region, and the second program interaction screen may be similar as described regarding FIGS. 2A-2C and FIGS. 4A-4D.

At block 714, the apparatus determines a second program interaction profile for the program based, at least in part, on the second display region. The determination and the second program interaction profile may be similar as described in FIGS. 3A-3C.

At block 716, the apparatus generates the second program interaction screen based, at least in part, on the second program interaction profile. The generation may be similar as described in FIGS. 4A-4D.

At block 718, the apparatus causes display of the second program interaction screen at a position that corresponds with the second display region. The causation may be similar as described in FIGS. 2A-2C and FIGS. 5A-5E.

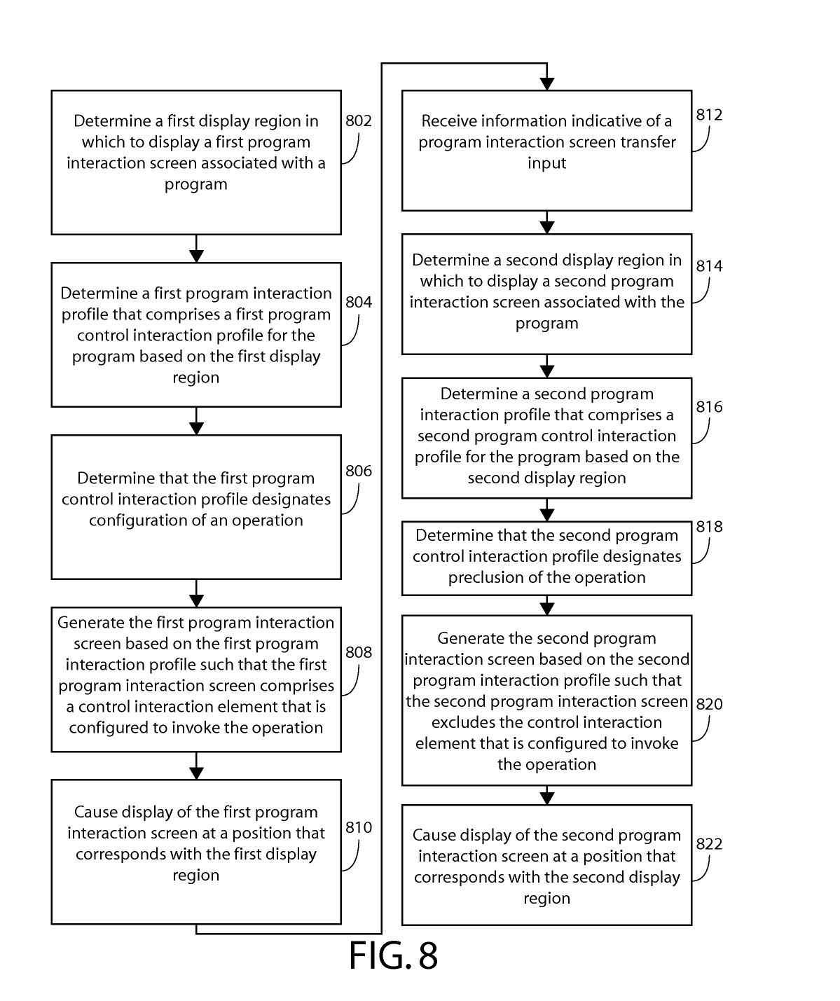

FIG. 8 is a flow diagram illustrating activities associated with determination of a program interaction profile based at least in part on a display region according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

As previously described, in some circumstances, it may be desirable to generate a program interaction screen based, at least in part, on a program interaction profile.

At block 802, the apparatus determines a first display region in which to display a first program interaction screen associated with a program, similarly as described regarding block 602 of FIG. 6. At block 804, the apparatus determines a first program control interaction profile based on the first display region. The determination and the first program control interaction profile may be similar as described in FIGS. 3A-3C.

At block 806, the apparatus determines that the first program control interaction profile designates configuration of an operation. The determination may be similar as described in FIGS. 3A-3C.

At block 808, the apparatus generates the first program interaction screen based on the first program interaction profile. In this manner, the first program interaction screen may comprise a control interaction element that is configured to invoke the operation. The generation and the control interaction element may be similar as described in FIGS. 3A-3C and FIGS. 4A-4D.

At block 810, the apparatus causes display of the first program interaction screen at a position that corresponds with the first display region, similarly as described regarding block 608 of FIG. 6. At block 812, the apparatus receives information indicative of a program interaction screen transfer input, similarly as described regarding block 710 of FIG. 7. At block 814, the apparatus determines a second display region in which to display a second program interaction screen associated with the program based, at least in part, on the interaction screen transfer input, similarly as described regarding block 712 of FIG. 7.

At block 816, the apparatus determines a second program interaction profile that comprises a second program control interaction profile for the program based on the second display region. The determination and the second program control interaction profile may be similar as described in FIGS. 3A-3C.

At block 818, the apparatus determines that the second program control interaction profile designates preclusion of the operation. The determination may be similar as described in FIGS. 3A-3C.

At block 820, the apparatus generates the second program interaction screen based on the second program interaction profile. In this manner, the second program interaction screen may exclude the control interaction element that is configured to invoke the operation. The generation and the exclusion may be similar as described in FIGS. 3A-3C and FIGS. 4A-4D.

At block 822, the apparatus causes of display of the second program interaction screen at a position that corresponds with the second display region, similarly as described regarding block 718 of FIG. 7.

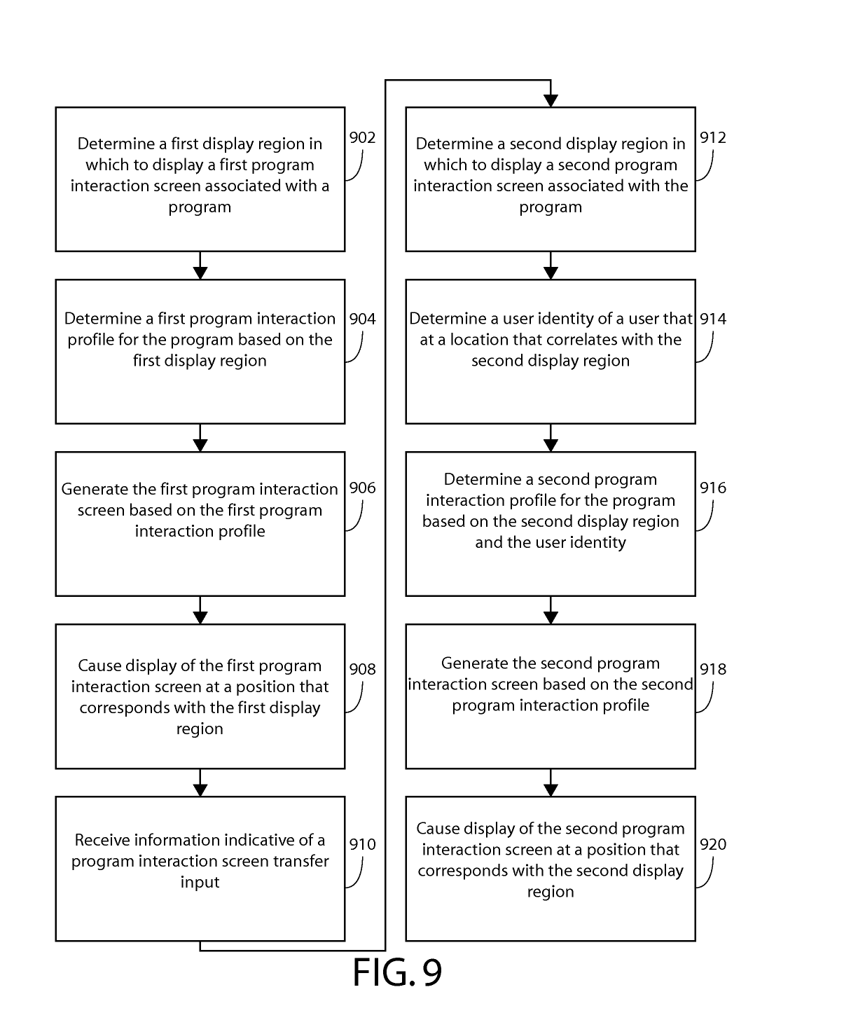

FIG. 9 is a flow diagram illustrating activities associated with determination of a program interaction profile based at least in part on a display region according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As previously described, in some circumstances, it may be desirable to determine a user identity of a user at a location that correlates with a display region. In such circumstances, it may be desirable to determine the program interaction profile based, at least in part, on the identity of the user.

At block 902, the apparatus determines a first display region in which to display a first program interaction screen associated with a program, similarly as described regarding block 602 of FIG. 6. At block 904, the apparatus determines a first program interaction profile for the program based, at least in part, on the first display region, similarly as described regarding block 604 of FIG. 6. At block 906, the apparatus generates the first program interaction screen based, at least in part, on the first program interaction profile, similarly as described regarding block 606 of FIG. 6. At block 908, the apparatus causes display of the first program interaction screen at a position that corresponds with the first display region, similarly as described regarding block 608 of FIG. 6. At block 910, the apparatus receives information indicative of a program interaction screen transfer input, similarly as described regarding block 710 of FIG. 7. At block 912, the apparatus determines a second display region in which to display a second program interaction screen associated with the program based, at least in part, on the interaction screen transfer input, similarly as described regarding block 712 of FIG. 7.

At block 914, the apparatus determines a user identity of a user that is at a location that correlates with the second display region. In this manner, the determination of a second program interaction profile for the program may be based, at least in part, on the user identity. The determination and the user identity may be similar as described in FIGS. 3A-3C.

At block 916, the apparatus determines a second program interaction profile for the program based, at least in part, on the second display region and the user identity. The determination and the second program interaction profile may be similar as described in FIGS. 3A-3C.

At block 918, the apparatus the apparatus generates the second program interaction screen based, at least in part, on the second program interaction profile, similarly as described regarding block 716 of FIG. 7. At block 920, the apparatus causes of display of the second program interaction screen at a position that corresponds with the second display region, similarly as described regarding block 718 of FIG. 7.

Embodiments of the invention may be implemented in software, hardware, application logic or a combination of software, hardware, and application logic. The software, application logic, and/or hardware may reside on the apparatus, a separate device, or a plurality of separate devices. If desired, part of the software, application logic, and/or hardware may reside on the apparatus, part of the software, application logic and/or hardware may reside on a separate device, and part of the software, application logic, and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 812 of FIG. 8 may be performed after block 814 of FIG. 8. Furthermore, if desired, one or more of the above-described functions may be optional or may be combined. For example, block 606 of FIG. 6 may be optional and/or combined with block 608 of FIG. 6.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
determination of a first display region in which to display a first program interaction screen associated with a program;
determination of a first program interaction profile for the program based, at least in part, on the first display region;
generation of the first program interaction screen based, at least in part, on the first program interaction profile;
causation of display of the first program interaction screen at a position that corresponds with the first display region;
receipt of information indicative of a program interaction screen transfer input;
determination of a second display region in which to display a second program interaction screen associated with the program based, at least in part, on the interaction screen transfer input;
determination of a second program interaction profile for the program based, at least in part, on the second display region;
generation of the second program interaction screen based, at least in part, on the second program interaction profile; and
causation of display of the second program interaction screen at a position that corresponds with the second display region.

2. The apparatus of claim 1, wherein the first program interaction profile comprises a first program control interaction profile, and generation of the first program interaction screen is based, at least in part, on the first program control interaction profile.

3. The apparatus of claim 2, wherein the generation of the first program interaction screen comprises determination that the first program control interaction profile designates configuration of an operation, the generation of the first program interaction screen is performed such that the first program interaction screen comprises a control interaction element that is configured to invoke the operation, the second program interaction profile comprises a second program control interaction profile, and generation of the second program interaction screen is based, at least in part, on the second program control interaction profile.

4. The apparatus of claim 3, wherein the generation of the second program interaction screen comprises determination that the second program control interaction profile designates preclusion of the operation, and the generation of the second program interaction screen is performed such that the second program interaction screen excludes the control interaction element that is configured to invoke the operation.

5. The apparatus of claim 2, wherein the generation of the first program interaction screen comprises determination that the first program control interaction profile designates preclusion of an operation, and the generation of the first program interaction screen is performed such that the first program interaction screen excludes a control interaction element that is configured to invoke the operation.

6. The apparatus of claim 5, wherein the second program interaction profile comprises a second program control interaction profile, and generation of the second program interaction screen is based, at least in part, on the second program control interaction profile.

7. The apparatus of claim 6, wherein the generation of the second program interaction screen comprises determination that the second program control interaction profile designates configuration of the operation, and the generation of the second program interaction screen is performed such that the second program interaction screen comprises the control interaction element that is configured to invoke the operation.

8. The apparatus of claim 1, wherein the memory includes computer program code configured to, working with the processor, cause the apparatus to perform:
determination of a user identity of a user that is at a location that correlates with the second display region, wherein the determination of the second program interaction profile for the program is based, at least in part, on the user identity.

9. The apparatus of claim 1, wherein the apparatus comprises a display.

10. A method comprising:
determining a first display region in which to display a first program interaction screen associated with a program;
determining a first program interaction profile for the program based, at least in part, on the first display region;
generating the first program interaction screen based, at least in part, on the first program interaction profile;
causing display of the first program interaction screen at a position that corresponds with the first display region;
receiving information indicative of a program interaction screen transfer input;
determining a second display region in which to display a second program interaction screen associated with the program based, at least in part, on the interaction screen transfer input;
determining a second program interaction profile for the program based, at least in part, on the second display region;
generating the second program interaction screen based, at least in part, on the second program interaction profile; and
causing display of the second program interaction screen at a position that corresponds with the second display region.

11. The method of claim 10, wherein the first program interaction profile comprises a first program control interaction profile, and generation of the first program interaction screen is based, at least in part, on the first program control interaction profile.

12. The method of claim 11, wherein generating the first program interaction screen comprises determining that the first program control interaction profile designates configuration of an operation, the generation of the first program interaction screen is performed such that the first program interaction screen comprises a control interaction element that is configured to invoke the operation, the second program interaction profile comprises a second program control interaction profile, and generation of the second program interaction screen is based, at least in part, on the second program control interaction profile.

13. The method of claim 12, wherein generating the second program interaction screen comprises determining that the second program control interaction profile designates preclusion of the operation, and the generation of the second program interaction screen is performed such that the second program interaction screen excludes the control interaction element that is configured to invoke the operation.

14. The method of claim 11, wherein generating first program interaction screen comprises determining that the first program control interaction profile designates preclusion of an operation, and the generation of the first program interaction screen is performed such that the first program interaction screen excludes a control interaction element that is configured to invoke the operation.

15. The method of claim 14, wherein the second program interaction profile comprises a second program control interaction profile, and generating the second program interaction screen is based, at least in part, on the second program control interaction profile.

16. The method of claim 15, wherein generating the second program interaction screen comprises determining that the second program control interaction profile designates configuration of the operation, and the generation of the second program interaction screen is performed such that the second program interaction screen comprises the control interaction element that is configured to invoke the operation.

17. At least one computer-readable medium encoded with instructions that, when executed by a processor, perform:
determination of a first display region in which to display a first program interaction screen associated with a program;
determination of a first program interaction profile for the program based, at least in part, on the first display region;
generation of the first program interaction screen based, at least in part, on the first program interaction profile;
causation of display of the first program interaction screen at a position that corresponds with the first display region;
receipt of information indicative of a program interaction screen transfer input;
determination of a second display region in which to display a second program interaction screen associated with the program based, at least in part, on the interaction screen transfer input;
determination of a second program interaction profile for the program based, at least in part, on the second display region;
generation of the second program interaction screen based, at least in part, on the second program interaction profile; and
causation of display of the second program interaction screen at a position that corresponds with the second display region.

18. The medium of claim 17, wherein the first program interaction profile comprises a first program control interaction profile, and generation of the first program interaction screen is based, at least in part, on the first program control interaction profile.

19. The medium of claim 18, wherein the generation of the first program interaction screen comprises determination that the first program control interaction profile designates configuration of an operation, the generation of the first program interaction screen is performed such that the first program interaction screen comprises a control interaction element that is configured to invoke the operation, the second program interaction profile comprises a second program control interaction profile, and generation of the second program interaction screen is based, at least in part, on the second program control interaction profile.

20. The medium of claim 19, wherein the generation of the second program interaction screen comprises determination that the second program control interaction profile designates preclusion of the operation, and the generation of the second program interaction screen is performed such that the second program interaction screen excludes the control interaction element that is configured to invoke the operation.
